(19) United States
(12) Patent Application Publication
(10) Pub. No.: US 2014/0001976 A1
(43) Pub. Date: Jan. 2, 2014

(54) COIL COMPONENT AND DISPLAY DEVICE INCLUDING THE SAME

(71) Applicants: Geun Young Park, Suwon (KR); Jong Woo Kim, Suwon (KR); Young Min Lee, Suwon (KR); Myeong Jeong Kim, Suwon (KR); Kwang Seung Cho, Suwon (KR)

(72) Inventors: Geun Young Park, Suwon (KR); Jong Woo Kim, Suwon (KR); Young Min Lee, Suwon (KR); Myeong Jeong Kim, Suwon (KR); Kwang Seung Cho, Suwon (KR)

(21) Appl. No.: 13/620,545

(22) Filed: Sep. 14, 2012

(30) Foreign Application Priority Data
Jun. 28, 2012 (KR) 10-2012-0070273

(51) Int. Cl. H01F 27/29; H05B 37/00

(52) U.S. Cl. 315/276; 336/192

(57) ABSTRACT

There is provided a coil component in which a plurality of coils may be easily connected to external connection terminals. The coil component includes: a bobbin including a winding part having a coil wound therearound and a terminal connection part having at least one external connection terminal connected thereto, the external connection terminal having a lead wire of the coil connected thereto; and at least one auxiliary terminal part coupled to the terminal connection part to allow for an increase in an amount of the external connection terminal.

### CROSS-REFERENCE TO RELATED APPLICATIONS

This application claims the priority of Korean Patent Application No. 10-2012-0070273 filed on Jun. 28, 2012, in the Korean Intellectual Property Office, the disclosure of which is incorporated herein by reference.

### BACKGROUND OF THE INVENTION

1. Field of the Invention

The present invention relates to a coil component, and more particularly, to a coil component in which a plurality of coils may be easily connected to external connection terminals.

2. Description of the Related Art

Various kinds of power supplies are required in various electronic devices such as televisions (TVs), monitors, personal computers (PCs), office automation (OA) devices, and the like. Therefore, these electronic devices generally include power supplies converting alternate current (AC) power supplied from the outside into power of different levels required by respective electronic appliances.

Among power supplies, a power supply using a switching mode (for example, a switching mode power supply (SMPS)) has recently mainly been used. A SMPS basically includes a switching transformer.

Generally, in a switching transformer, core and bobbin sizes may be significantly reduced as compared to those in a general transformer. In addition, the switching transformer may stably supply low voltage and low current direct current (DC) power to the electronic appliance. Therefore, switching transformers have been widely used in electronic appliances that tend to be miniaturized.

Meanwhile, in accordance with the complexity of an electronic device, various attempts to receive various voltages rather than a single voltage from a single transformer have been attempted. Therefore, a primary coil and a secondary coil have also been provided in a form in which several strands of coils are wound.

However, in the case in which a plurality of coils are wound in a small transformer as described above, the amount of lead wires of the respective coils, that is, the number of lead wires of the respective coils is significantly increased, such that it may be difficult to connect the respective lead wires to external connection terminals.

In addition, these problems have been further intensified in the case in which a coil component is manufactured by automatically winding the coils.

### RELATED ART DOCUMENT

(Patent Document 1) Korean Patent Laid-Open Publication No. 2000-0011091

### SUMMARY OF THE INVENTION

An aspect of the present invention provides a coil component in which coils may be easily connected to external connection terminals.

Another aspect of the present invention provides a coil component in which external connection terminals may be disposed variously and coils may be connected to the external connection terminals.

According to an aspect of the present invention, there is provided a coil component including: a bobbin including a winding part having a coil wound therearound and a terminal connection part having at least one external connection terminal connected thereto, the external connection terminal having a lead wire of the coil connected thereto; and at least one auxiliary terminal part coupled to the terminal connection part to allow for an increase in an amount of the external connection terminal.

The auxiliary terminal part may include at least one terminal pin.

The terminal connection part may include at least one coupling groove having the auxiliary terminal part inserted thereinto and coupled thereto.

The terminal connection part may include at least one fitting groove formed in the coupling groove and having a part of the auxiliary terminal part fitted thereinto.

The auxiliary terminal part may include a coupling protrusion inserted into the coupling groove and at least one fitting protrusion protruding from a distal end of the coupling protrusion and fitted into the fitting groove.

The auxiliary terminal part may include at least one coupling protrusion protruding outwardly; and at least one coupling groove into which a coupling protrusion of another auxiliary terminal part is inserted.

The auxiliary terminal part may include: at least one coupling protrusion protruding outwardly; and at least one coupling groove into which a coupling protrusion of another auxiliary terminal part is inserted.

The terminal connection part may include a plurality of guide protrusions protruding outwardly, and the auxiliary terminal part may be coupled to the terminal connection part while being inserted into a space between the guide protrusions.

The coil may pass through a space between the guide protrusions and be connected to the external connection terminal.

The coil component may further include: a core coupled to the bobbin to thereby be electromagnetically coupled to the coil; and at least one insulating cover interposed between the bobbin and the core to insulate the coil and the core from one another.

The external connection terminal may include a plurality of external connection terminal disposed in two rows or more by the auxiliary terminal part.

According to another aspect of the present invention, there is provided a coil component including: a bobbin including a winding part having a coil wound therearound and a terminal connection part having external connection terminals disposed in a row, the external connection terminals having a lead wire of the coil connected thereto; and at least one auxiliary terminal part coupled to the terminal connection part to allow the external connection terminals to be extended in two rows or more.

The auxiliary terminal part may include: at least one terminal pin coupled to a body; and at least one fitting protrusion protruding from the body in a direction perpendicular with regard to the terminal pin and fitted into the terminal connection part.

According to another aspect of the present invention, there is provided a display apparatus including: a switching mode power supply having at least one coil component as described above mounted on a substrate; a display panel receiving power supplied from the switching mode power supply; and a cover protecting the display panel and the switching mode power supply.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a coil component according to an embodiment of the present invention;

FIG. 2 is an exploded perspective view of the coil component shown in FIG. 1;

FIG. 3 is a bottom perspective view schematically illustrating a bobbin of FIG. 2;

FIG. 4 is a perspective view schematically illustrating a coil component according to another embodiment of the present invention;

FIG. 5 is an exploded perspective view of the coil component shown in FIG. 4;

FIG. 6 is a bottom perspective view schematically illustrating a bobbin of FIG. 5; and

FIG. 7 is an exploded perspective view schematically illustrating a display device according to the embodiment of the present invention.

### DETAILED DESCRIPTION OF THE INVENTION

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, embodiments of the present invention will be described in detail with reference to the accompanying drawings. At this time, it is noted that like reference numerals denote like elements in appreciating the drawings. In addition, it is to be noted that some components shown in the drawings are exaggerated, omitted or schematically illustrated, and the size of each component does not exactly reflect its real size.

Hereinafter, embodiments of the present invention will be described in detail with reference to the accompanying drawings.

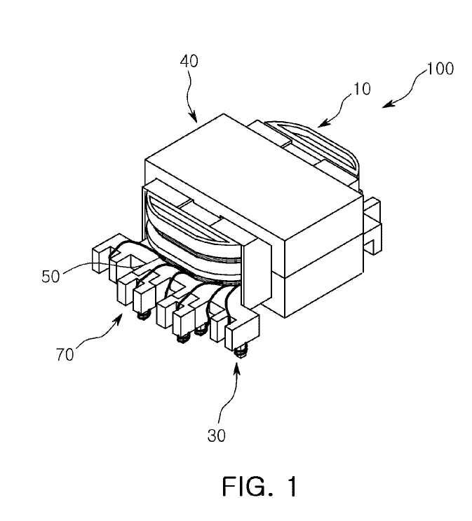

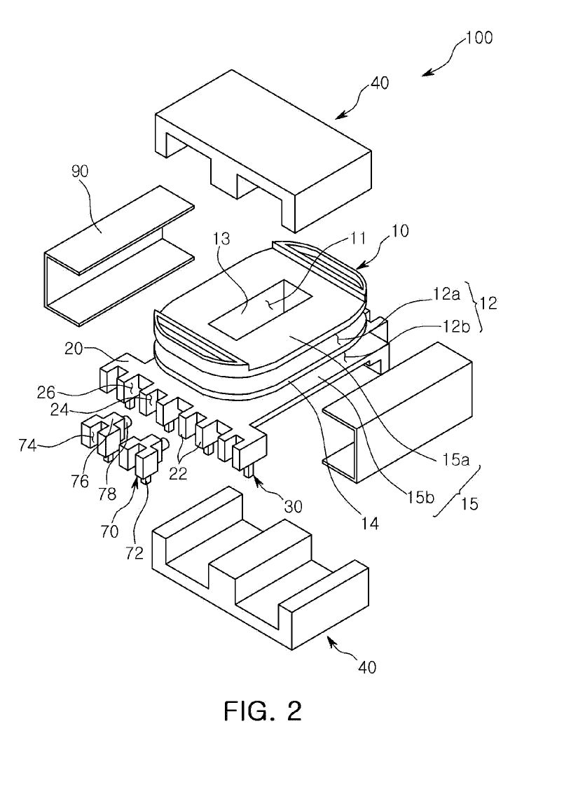

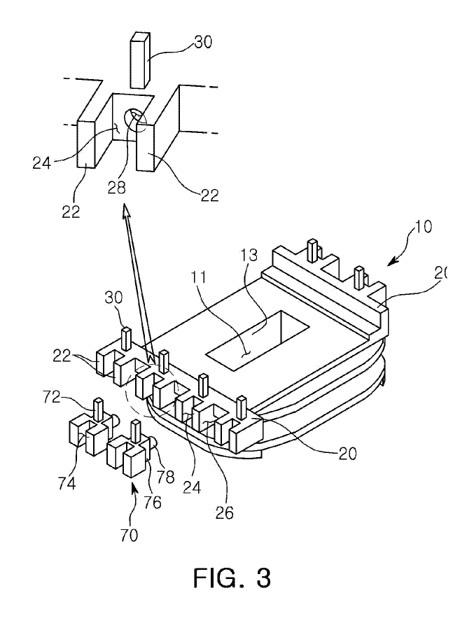

FIG. 1 is a perspective view schematically illustrating a coil component according to an embodiment of the present invention; and FIG. 2 is an exploded perspective view of the coil component shown in FIG. 1, wherein a coil is omitted. FIG. 3 is a bottom view schematically illustrating a bobbin of FIG. 2.

Referring to FIGS. 1 through 3, a coil component 100 according to the embodiment of the present invention may be an insulating type switching transformer and may include a bobbin 10, a core 40, a coil 50, and an auxiliary terminal part 70.

The bobbin 10 may form an overall body of the coil component 100. The bobbin 10 may be easily manufactured by injection molding, but is not limited thereto. In addition, the bobbin 10 according to the present embodiment may be formed of an insulating resin and be formed of a material having high heat resistance and high voltage resistance. As a material of the bobbin 10, for example, polyphenylenesulfide (PPS), liquid crystal polyester (LCP), polybutyleneterephthalate (PBT), polyethyleneterephthalate (PET), phenolic resin, or the like, may be used.

The bobbin 10 may include a winding part 12 having the coil 50 wound therearound and a terminal connection part 20 formed at one end of the winding part 12.

The winding part 12 may include a body part 13 having a pipe form and a flange part 15 extended from both ends of the body part 13 in an outer diameter direction.

The body part 13 may include a through-hole 11 formed in an inner portion thereof and at least one partition wall 14 formed at an outer peripheral surface thereof. In this case, the through hole 11 has a part of the core 40 inserted thereinto and the partition wall 14 partitions spaces in a length direction of the body part 13. In this configuration, the coil 50 may be wound in respective spaces partitioned by the partition wall 14.

The winding part 12 according to the present embodiment may include a single partition wall 14. Therefore, the winding part 12 according to the present embodiment may include two partitioned spaces 12a and 12b. However, the present invention is not limited thereto. That is, a plurality of spaces may be formed and used through a plurality of partition walls 14 as required.

The partition wall 14 may have various thicknesses and be formed of various materials as long as a form thereof may be maintained. In addition, although the case in which the partition wall 14 is formed integrally with the bobbin 10 has been described by way of example in the present embodiment, the present invention is not limited thereto, but may be variously applied. For example, the partition wall 14 may also be formed as an independent separate member and coupled to the bobbin 10.

The partition wall 14 according to the present embodiment may have approximately the same form as that of an upper flange part 15a to be described below.

The flange part 15 may protrude in such a manner that the flange part 15 is extended from both ends of the body part 13, that is, upper and lower ends thereof, in the outer diameter direction. The flange part 15 according to the present embodiment may be divided into the upper flange part 15a and a lower flange part 15b according to a formation position thereof.

In addition, spaces formed between the outer peripheral surface of the body part 13 and the upper and lower flange parts 15a and 15b may be provided as the spaces 12a and 12b around which the coil 50 is wound. Therefore, the flange part 15 may serve to protect the coil 50 from the outside and secure insulation properties between the coil 50 and the outside, simultaneously with serving to support the coil 50 wound around the winding spaces 12a and 12b at both sides thereof.

The terminal connection part 20 may be formed on the lower flange part 15b. More specifically, the terminal connection part 20 according to the present embodiment may be formed to protrude from the lower flange part 15b in the outer diameter direction in order to secure an insulation distance.

However, the present invention is not limited thereto. That is, the terminal connection part 20 may also be formed to protrude downwardly of the lower flange part 15b.

Meanwhile, referring to FIG. 2, since the terminal connection part 20 according to the present embodiment may be formed in such a manner that the terminal connection part 20 is partially extended from the lower flange part 15b, it may be difficult to clearly distinguish between the lower flange part 15b and the terminal connection part 20. Therefore, in the terminal connection part 20 according to the present embodiment, the lower flange part 15b itself may also be perceived as the terminal connection part 20.

External connection terminals 30 may be connected to the terminal connection part 20 in a form in which they protrude outwardly.

In addition, the terminal connection part 20 according to the present embodiment may be divided into a primary terminal connection part and a secondary terminal connection part according to a winding order of the coil 50 connected to the external connection terminal 30.

In addition, the terminal connection part 20 according to the present embodiment may include a plurality of guide protrusions 22, a plurality of coupling grooves 24, and a plurality of guide grooves 26.

The plurality of guide protrusions 22 may be formed to protrude from a side of the terminal connection part 20 in the outer diameter direction of the body part.

The guide protrusions 22 may be provided to guide a lead wire of the coil 50 wound around the winding part 12 so as to allow the lead wire to be easily connected to the external connection terminal 30 at a lower portion of the terminal connection part 20, as shown in FIG. 1, FIG. 2. Therefore, the guide protrusions 22 may protrude beyond a diameter of the lead wire of the coil 50 so as to guide the coil 50 disposed therebetween while firmly supporting the coil 50.

The coupling groove 24 and the guide groove 26 may be formed by the guide protrusion 22. That is, the coupling groove 24 and the guide groove 26 may be formed in the side of the terminal connection part 20 in an inner diameter direction of the body 13.

The coupling groove 24 may be a single groove or a plurality of independent grooves formed corresponding to a position in which the respective external connection terminals 30 are disposed.

In the case in which an auxiliary terminal part 70 is not coupled to the coupling groove 24, the coupling groove 24 may be used as a path through which the lead wire of the coil 50 wound around the winding part 12 is led to a lower portion of the terminal connection part 20. That is, the lead wire led from the winding part 12 may be inserted into the coupling groove 24, pass through the coupling groove 24, and be then connected to the external connection terminal 30. Therefore, the coupling groove 24 may have a width wider than a thickness (that is, a diameter) of the coil 50.

In addition, the coupling groove 24 may be used as a groove into which a coupling protrusion 76 of an auxiliary terminal part 70 to be described below is inserted. Therefore, the coupling groove 24 may have a width corresponding to a shape of the coupling protrusion 76 of the auxiliary terminal part 70.

In order to firmly couple the coupling groove 24 and the auxiliary terminal part 70 to each other, the coupling groove 24 may include at least one fitting groove 28 formed therein, as shown in FIG. 3. The fitting groove 28 may be a groove into which a fitting protrusion 78 of an auxiliary terminal part 70 to be described is insertedly fitted. Therefore, the fitting groove 28 may have a shape and a size corresponding to those of the fitting protrusion 78.

The guide groove 26 may be formed by the guide protrusion 22, similar to the coupling groove 24, and be formed between the respective coupling grooves 24. Therefore, the guide grooves 26 according to the present embodiment may be a plurality of independent grooves disposed between the respective external connection terminals 30.

The guide groove 26 may be used as the path through which the lead wire of the coil 50 wound around the winding part 12 is led to the lower portion of the terminal connection part 20. That is, the lead wire led from the winding part 12 may be inserted into the guide groove 26, pass through the guide groove 26, and be then connected to the external connection terminal 30. Therefore, the guide groove 26 may have a width wider than the diameter of the coil 50, similar to the coupling groove 24.

Meanwhile, the case in which the guide groove 26 and the coupling groove 24 are clearly distinguished from each other has been described by way of example in the present embodiment. However, the present invention is not limited thereto. That is, in the case in which all of the guide grooves 26 have a form of the coupling groove 24 (that is, in the case in which all of the guide grooves 26 are formed to have a fitting groove formed therein and have a width corresponding to that of the coupling protrusion), the guide groove 26 may be omitted and all of the grooves formed by the guide protrusion 22 may be used as the coupling grooves 24.

In addition, although not shown, the coupling groove 24 may have a bottom surface and an edge portion that are inclined at a predetermined angle or curved (for example, chamfered) in order to significantly reduce the bending of the lead wire connected to the external connection terminal 30 at an edge portion of the terminal connection part 20.

The terminal connection part 20 may include a plurality of the external connection terminals 30 connected thereto. The external connection terminals 30 may protrude outwardly from the terminal connection part 20 and have various forms according to a shape or a structure of the coil component 100 or a structure of a substrate on which the coil component 100 is mounted.

The case in which four primary external connection terminals 30 and two secondary external connection terminals 30 are connected to the terminal connection part 20 has been described by way of example in the present embodiment shown in FIG. 3.

However, in the coil component 100 according to the present invention, the amount of the external connection terminals 30, that is, the number of external connection terminals 30 is not limited to thereto, but may be changed as needed.

Further, in the coil component 100 according to the present invention, the amount of the external connection terminals 30 (the number of external connection terminals 30) may be easily increased using the auxiliary terminal part 70. A detailed description thereof will be provided below.

The auxiliary terminal part 70 may be insertedly coupled to the coupling groove 24 of the terminal connection part 20 to increase the number of external connection terminals 30.

To this end, the auxiliary terminal part 70 may include a body having an approximately Y-shape and at least one terminal pin 72 connected to the body.

The body of the auxiliary terminal part 70 may form an overall appearance of the auxiliary terminal part 70. In addition, the body of the auxiliary terminal part 70 may include a coupling protrusion inserted into the coupling groove 24 of the terminal connection part 20 and a coupling groove 74.

The coupling protrusion 76 may be inserted into the coupling groove 24 formed in the terminal connection part 20 as described above. Therefore, the coupling protrusion 76 may have a shape corresponding to that of the coupling groove 24 of the terminal connection part 20.

In addition, the coupling protrusion 76 may have at least one fitting protrusion 78 formed at a distal end thereof. The fitting protrusion 78, which is fitted into the fitting groove 28 of the terminal connection part 20, may have a shape and a size corresponding to those of the fitting groove 28.

In addition, the body of the auxiliary terminal part 70 may have at least one coupling groove 74 formed therein. The coupling groove 74 of the auxiliary terminal part 70 may be coupled to the coupling protrusion 76 of another auxiliary terminal part 70, similar to the coupling groove 24 of the terminal connection part 20. That is, as in another embodiment of the present invention to be described below, a plurality of auxiliary terminal parts 70 may be coupled to each other in a form in which they are stacked and be coupled to the terminal connection part 20.

Therefore, the coupling groove 74 of the auxiliary terminal part 70 may have the same shape and size as the coupling groove 24 of the terminal connection part 20. Further, a fitting groove into which the fitting protrusion 78 of another auxiliary terminal part 70 is fitted may be formed in the coupling groove 74.

The terminal pin 72 may be used as the external connection terminal 30. Therefore, the terminal pin 72 may have the same shape as that of the external connection terminal 30 of the terminal connection part 20. Therefore, the terminal pin 72 is not limited to having the above-mentioned form, but may also have other shapes as needed and according to a coupling position thereof.

Further, according to the present embodiment, when the auxiliary terminal part 70 is coupled to the terminal coupling part 20, the terminal pin 72 may be disposed so as to protrude in the same direction as a direction in which the external connection terminals 30 are disposed. However, the present invention is not limited thereto, but may be variously applied. For example, the terminal pin 72 may be configured to protrude in a direction different from the direction in which the external connection terminals 30 of the terminal connection part 20 are disposed.

The auxiliary terminal part 70 may be easily manufactured by injection molding, similar to the bobbin 10, but is not limited thereto. In addition, the auxiliary terminal part 70 according to the present embodiment may be formed of an insulating resin and be formed of a material having high heat resistance and high voltage resistance. As a material of the auxiliary terminal part 70, for example, polyphenylenesulfide (PPS), liquid crystal polyester (LCP), polybutyleneterephthalate (PBT), polyethyleneterephthalate (PET), phenolic resin, or the like, may be used.

The auxiliary terminal part 70 according to the present embodiment configured as described above was derived in consideration of the case in which the coil 50 are automatically wound around the bobbin 10.

That is, in the bobbin 10 according to the present embodiment, a process of winding the coil 50 around the bobbin 10, a process of connecting the lead wire of the coil 50 to the external connection terminal 30, and the like, may be automatically performed through a separate automatic winding device (not shown).

In the processes, since the coil is wound around the external connection terminals 30 by a separate automatic winding device, the external connection terminals 30 need to secure at least an spaced distance therebetween such that a nozzle (a part winding the coil while unbinding the coil) of the automatic winding device may pass therebetween in order to connect the coil thereto.

However, in the case in which the plurality of external connection terminals 30 (for example, six primary external connection terminals) are provided in accordance with a plurality of coils being used, the plurality of external connection terminals 30 are disposed to be extended in a raw, such that the overall size of the coil component may be increased according to the related art.

Therefore, in the coil component 100 according to the present embodiment, the external connection terminals 30 are disposed in multiple rows rather than a single row, whereby the increase in the size of the coil component may be significantly suppressed.

In addition, a second row (an outer row) of the external connection terminals 30 is not fixed to the bobbin 10, but may be coupled to the auxiliary terminal part 70. Therefore, the external connection terminals 30 may be disposed in various numbers and various forms as needed in the second row.

Further, in the coil component 100 according to the present embodiment, another auxiliary terminal part 70 may be coupled to the auxiliary terminal part 70. Therefore, the external connection terminals 30 are not limited to being formed in two rows, but may be formed in three rows or more.

Further, in the coil component 100 according to the present embodiment, the external connection terminals 30 are formed in two rows or more rather than a single row, such that a plurality of coils may be connected to the external connection terminals 30 through various paths (the guide grooves and the coupling grooves of the terminal connection part, the coupling grooves of the auxiliary terminal part, and the like).

Therefore, even in the case in which the plurality of coils are wound around a single bobbin 10, an intersection or contact between lead wires of the coils during a process of leading the lead wires of the coils to the external connection terminals 30 may be significantly reduced.

The core 40 may have a part inserted into the through-hole 11 formed in the bobbin 10 and be electromagnetically coupled to the coil 50 to form a magnetic path.

The core 40 according to the present embodiment may include a pair of cores and parts of the pair of cores 40 may be inserted into the through-hole 11 of the bobbin 10, such that the pair of cores 40 may be coupled to each other so as to contact each other. As the core 40, an ‘EE’ core, an ‘EI’ core, a ‘UU’ core, a ‘UI’ core, and the like, according to a shape thereof, may be used.

The core 40 may be formed of Mn—Zn based ferrite having higher permeability, lower loss, higher saturation magnetic flux density, higher stability, and lower production costs, as compared to other materials. However, in the embodiment of the present invention, a shape or a material of the core 40 is not limited.

Meanwhile, in order to secure insulation properties between the coil 50 wound around the bobbin 10 and the core 40, an insulating cover 90 may be interposed between the bobbin 10 and the core 40.

The insulating cover 90 may be interposed between the bobbin 10 and the core 40, corresponding to the overall inner surface of the core 40 facing the bobbin 10, or be partially interposed therebetween only at a portion at which the coil 50 and the core 40 face each other.

As the insulating cover 90, insulating tape may be used. However, the present invention is not limited thereto. That is, as shown in the accompanying drawings, various shaped-members, for example, an insulating member formed of an insulating material such as a resin, or the like, coupled to the bobbin 10, and having a ‘E’ shaped cross section, and the like, may be used as needed.

The coil 50 may be wound around the winding part 12 of the bobbin 10 and include the primary and secondary coils.

Each of the primary coil and the secondary coil may include a plurality of individual coils that are electrically insulated from each other. The case in which the primary coil includes three individual coils and the secondary coil includes a single individual coil has been described by way of example in the present embodiment.

Therefore, the primary coil may use six external connection terminals 30 and the secondary coil may use two external connection terminals 30.

However, the present invention is not limited thereto. That is, the number of individual coils of the respective primary and secondary coils may be appropriately changed as needed.

Each of the primary coil and the secondary coil according to the present embodiment may be wound around the spaces partitioned by the partition wall 14. The insulation between the primary coil and the secondary coil may be maintained by the partition wall.

Meanwhile, the coil 50 according to the present embodiment may be a general insulating coil (for example, a polyurethane wire), or the like, and a twisted pair wire-shaped coil formed by twisting several strands of wires (for example, a Litz wire, or the like) may be used. In addition, a multi-insulated coil (for example, a triple insulated wire (TIW)) having high insulating properties may be used. That is, kinds of the coil may be selected as needed.

The coil component according to the present embodiment configured as described above may include the auxiliary terminal part, separately from the bobbin. In addition, the auxiliary terminal part is selectively coupled to the bobbin, whereby the number and the position of external connection terminals may be selected as needed.

Therefore, coils having various shapes may be selectively wound and used through a single coil component and external connection terminals may be appropriately disposed and used according to shapes or kinds of wound coils, an electrical condition under which the coil component is applied, or the like. Therefore, the coil component according to the present embodiment may be easily used in various devices.

In addition, the external connection terminals are formed in two or more rows rather than a single row to provide various paths through which the lead wires of the coils may be connected to the external connection terminals, whereby the intersection or the contact between the lead wires of the coils during the process of leading the lead wires of the coils to the external connection terminals may be significantly reduced.

Further, even in the case in which a large number of external connection terminals are provided, a distance between the external connection terminals is easily secured, whereby the coil may be automatically wound using the automatic winding device.

Meanwhile, the present invention is not limited to the above-mentioned configuration, but may be variously applied as needed.

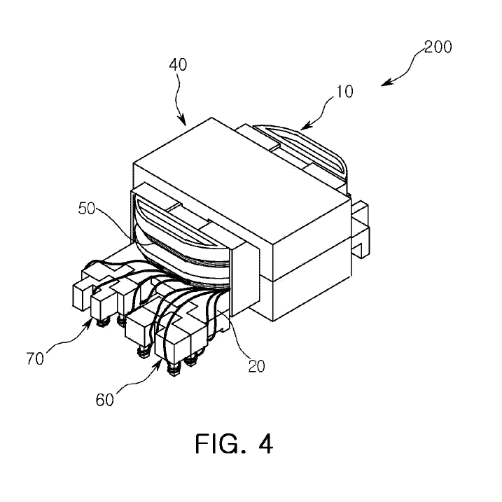

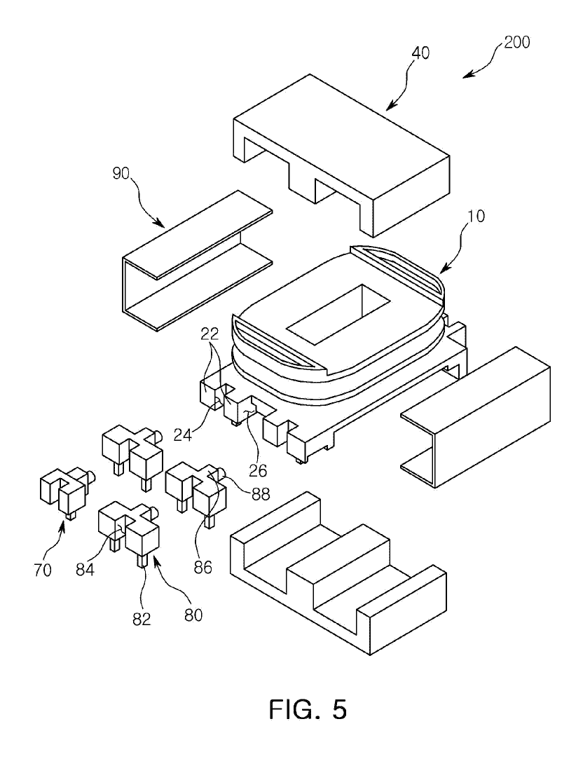

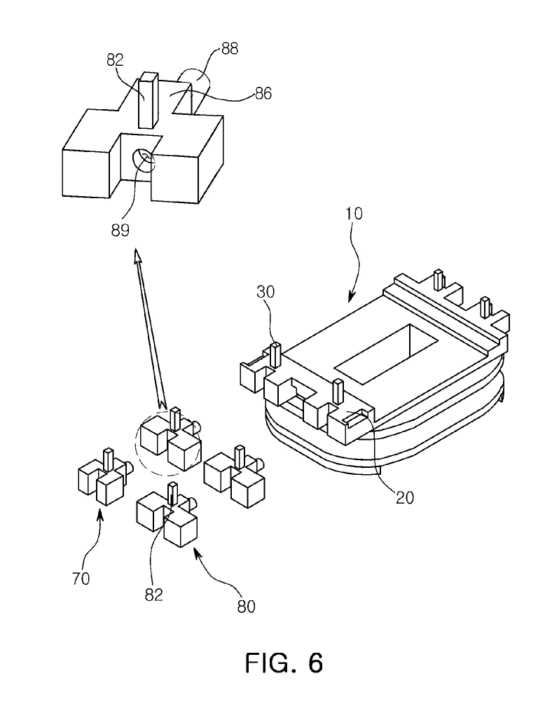

FIG. 4 is a perspective view schematically illustrating a coil component according to another embodiment of the present invention; FIG. 5 is an exploded perspective view of the coil component shown in FIG. 4; and FIG. 6 is a bottom perspective view schematically illustrating a bobbin of FIG. 5.

A coil component 200 according to the present embodiment is mainly different in configurations of the terminal connection part 20 of the bobbin 10 and auxiliary terminal parts 70 and 80 from the coil component 100 according to the above-mentioned embodiment of the present invention. Therefore, a detailed description of a configuration the same as that of the above-mentioned embodiment will be omitted and a configuration different therefrom will be mainly described.

The terminal connection part 20 of the coil component 200 according to the present embodiment may include at least one guide groove 26 and at least one coupling groove 24, similar to the terminal connection part 20 of the coil component 100 the above-mentioned embodiment.

In addition, only two external connection terminals 30 may be connected to the primary terminal connection part of the terminal connection part 20 according to the present embodiment. However, this is to prevent the overall size of the coil component 200 from being increased due to protrusion of the terminal connection part 20 from the bobbin 10. Therefore, the present invention is not limited thereto.

The auxiliary terminal part 80 according to the present embodiment may include a coupling groove 84, a coupling protrusion 86, and a fitting groove 89, similar to the auxiliary terminal part 80 according to the above-mentioned embodiment.

Particularly, the auxiliary terminal part 80 according to the present embodiment may include terminal pins 82 disposed at both sides thereof based on the coupling groove 84. That is, the auxiliary terminal part 80 according to the present embodiment may have two terminal pins 82.

Therefore, a body of the auxiliary terminal part 80 may have a width greater than that of the auxiliary terminal part 70 according to the above-mentioned embodiment.

As described above, the auxiliary terminal part 80 may be changed variously, as needed. That is, the number of terminal pins may also be four or more rather than two. In addition, as shown in FIGS. 4 through 6, the auxiliary terminal part 80 may be used together with the auxiliary terminal part 70 according to the above-mentioned embodiment.

Further, a plurality of the auxiliary terminal parts 70 and 80 may be coupled to each other in a form in which they are stacked and be then coupled to the terminal connection part 20. That is, the auxiliary terminal parts 70 and 80 having an appropriate shape may be coupled to each other as needed, and the terminal pins (that is, external connection terminals) may be disposed in a desired form and then coupled to the bobbin 10.

As described above, in the coil component 200 according to the present embodiment, a plurality of the auxiliary terminal parts 70 and 80 having various forms may be prepared and may be appropriately selected as needed and then be coupled to the bobbin 10. Therefore, the coil component 200 according to the present embodiment may be used for various purposes.

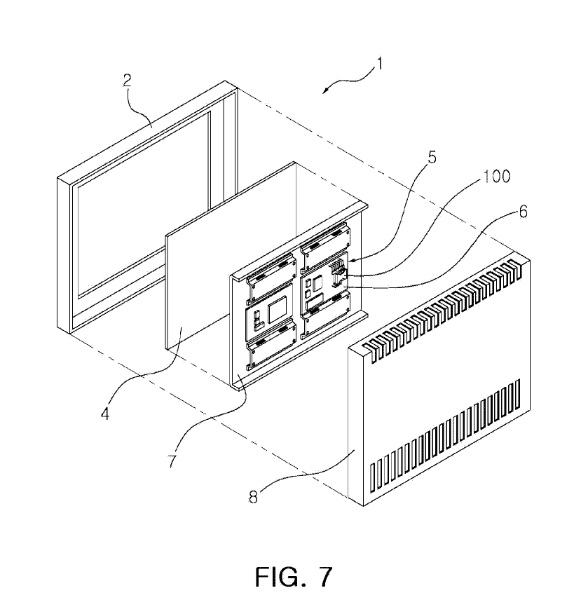

FIG. 7 is an exploded perspective view schematically illustrating a display device according to the embodiment of the present invention.

Referring to FIG. 7, a display device 1 according to the embodiment of the present invention may include a display panel 4, a switching mode power supply (SMPS) 5 having the coil component 100 mounted therein, and covers 2 and 8.

The covers 2 and 8 may include a front cover 2 and a back cover 8 and may be coupled to each other to thereby form a space therebetween.

The display panel 4 may be disposed in an internal space formed by the covers 2 and 8. As the display panel 4, various flat panel display panels such as a liquid crystal display (LCD), a plasma display panel (PDP), an organic light emitting diode (OLED), and the like, may be used.

The SMPS 5 may provide power to the display panel 4. The SMPS 5 may be formed by mounting a plurality of electronic components on a printed circuit board 6 and particularly, may include at least one of the coil components 100 and 200 according to the above-mentioned embodiments mounted therein.

The SMPS 5 may be fixed to a chassis 7 and be fixedly disposed in the internal space formed by the covers 2 and 8, together with the display panel 4.

The coil component according to the present invention as described above is not limited to the above-mentioned embodiments, and may be variously applied. For example, among coil components, the insulating type switching transformer has been described by way of example in the above-mentioned embodiments. However, the present invention is not limited thereto, and a component using a wound coil, such as a transformer for an inverter, a high frequency filter, or the like, and an electronic device including the same may be variously applied.

As set forth above, the coil component according to the embodiments of the present invention includes the auxiliary terminal part, separately from the bobbin. In addition, the auxiliary terminal part is selectively coupled to the bobbin, whereby the number and the position of external connection terminals may be selected as needed.

Therefore, since an arrangement of the external connection terminals may be appropriately changed according to a form or a kind of wound coil, an electrical condition under which the coil component is applied, or the like, the coil component may be easily used in various devices.

Further, in the coil component according to the embodiments of the present invention, the external connection terminals are formed in two or more rows rather than one row to provide various paths through which the lead wires of the coils may be connected to the external connection terminals, whereby the intersection or the contact between the lead wires of the coils during the process of leading the lead wires of the coils to the external connection terminals may be significantly reduced.

Further, since the external connection terminals are arranged in multiple rows, even in the case in which a large number of external connection terminals are provided, a distance between the external connection terminals is easily secured, whereby the coil may be automatically wound using the automatic winding device.

While the present invention has been shown and described in connection with the embodiments, it will be apparent to those skilled in the art that modifications and variations can be made without departing from the spirit and scope of the invention as defined by the appended claims.

What is claimed is:

1. A coil component comprising:
a bobbin including a winding part having a coil wound therearound and a terminal connection part having at least one external connection terminal connected thereto, the external connection terminal having a lead wire of the coil connected thereto; and
at least one auxiliary terminal part coupled to the terminal connection part to allow for an increase in an amount of the external connection terminal.

2. The coil component of claim 1, wherein the auxiliary terminal part includes at least one terminal pin.

3. The coil component of claim 1, wherein the terminal connection part includes at least one coupling groove having the auxiliary terminal part inserted thereinto and coupled thereto.

4. The coil component of claim 3, wherein the terminal connection part includes at least one fitting groove formed in the coupling groove and having a part of the auxiliary terminal part fitted thereinto.

5. The coil component of claim 4, wherein the auxiliary terminal part includes a coupling protrusion inserted into the coupling groove and at least one fitting protrusion protruding from a distal end of the coupling protrusion and fitted into the fitting groove.

6. The coil component of claim 1, wherein the auxiliary terminal part includes a plurality of auxiliary terminal parts coupled to each other in a form in which they are stacked and coupled to the terminal connection part.

7. The coil component of claim 6, wherein the auxiliary terminal part includes:
at least one coupling protrusion protruding outwardly; and
at least one coupling groove into which a coupling protrusion of another auxiliary terminal part is inserted.

8. The coil component of claim 1, wherein the terminal connection part includes a plurality of guide protrusions protruding outwardly, and the auxiliary terminal part is coupled to the terminal connection part while being inserted into a space between the guide protrusions.

9. The coil component of claim 1, wherein the terminal connection part includes a plurality of guide protrusions protruding outwardly, and the coil passes through a space between the guide protrusions and is connected to the external connection terminal.

10. The coil component of claim 1, further comprising:
a core coupled to the bobbin to thereby be electromagnetically coupled to the coil; and
at least one insulating cover interposed between the bobbin and the core to insulate the coil and the core from one another.

11. The coil component of claim 1, wherein the external connection terminal includes a plurality of external connection terminal disposed in two rows or more by the auxiliary terminal part.

12. A coil component comprising:
a bobbin including a winding part having a coil wound therearound and a terminal connection part having external connection terminals disposed in a row, the external connection terminals having a lead wire of the coil connected thereto; and
at least one auxiliary terminal part coupled to the terminal connection part to allow the external connection terminals to be extended in two rows or more.

13. The coil component of claim 12, wherein the auxiliary terminal part includes:
at least one terminal pin coupled to a body; and
at least one fitting protrusion protruding from the body in a direction perpendicular with regard to the terminal pin and fitted into the terminal connection part.

14. A display apparatus comprising:
a switching mode power supply having at least one coil component of claim 1 mounted on a substrate;
a display panel receiving power supplied from the switching mode power supply; and
a cover protecting the display panel and the switching mode power supply.
